(19) United States
(12) Patent Application Publication
(10) Pub. No.: US 2026/0171451 A1
(43) Pub. Date: Jun. 18, 2026

(54) DEVICE AND METHOD FOR CONTROLLING A HYDROGEN ELECTRIC VEHICLE

(71) Applicants: HYUNDAI MOTOR COMPANY, Seoul (KR); KIA CORPORATION, Seoul (KR)

(72) Inventors: Hae Jun Jeong, Hwaseong-si (KR); Min Chan Kwak, Hwaseong-si (KR); Hoe Jo Jeong, Hwaseong-si (KR); Yoon Geun Cho, Hwaseong-si (KR)

(73) Assignees: HYUNDAI MOTOR COMPANY, Seoul (KR); KIA CORPORATION, Seoul (KR)

(21) Appl. No.: 19/229,524

(22) Filed: Jun. 5, 2025

(30) Foreign Application Priority Data
Dec. 17, 2024 (KR) 10-2024-0188839

(51) Int. Cl. H01M 8/04746; B60H 1/00; B60L 15/20; B60L 50/75; B60L 58/12; B60L 58/30; H01M 8/04082; H01M 8/0444; H01M 8/0662

(52) U.S. Cl. CPC H01M 8/04753; B60H 1/00392; B60H 1/00821; B60L 15/20; B60L 50/75; B60L 58/12; B60L 58/30; H01M 8/04201; H01M 8/04455; H01M 8/0687; B60L 2240/12; B60L 2240/66; B60L 2250/16; B60L 2260/20; H01M 2250/20

(57) ABSTRACT

A device for controlling a hydrogen electric vehicle includes a valve that opens and closes an inlet pipe configured to supply outside air to a fuel cell of the vehicle and a processor that controls the valve. The processor determines location information of the vehicle and enters an outside air blocking mode to close the valve, based on the vehicle being located in a polluted area.

### CROSS-REFERENCE TO RELATED APPLICATION

This application claims the benefit of and priority to Korean Patent Application No. 10-2024-0188839, filed in the Korean Intellectual Property Office on Dec. 17, 2024, the entire contents of which are incorporated herein by reference.

### TECHNICAL FIELD

The present disclosure relates to a device and method for controlling a hydrogen electric vehicle, and more particularly, relates to a technology for controlling a vehicle in an air-polluted area.

### BACKGROUND

A fuel cell-based vehicle operates driving devices of the vehicle using energy produced by a fuel cell. The fuel cell produces electricity using a chemical reaction of hydrogen and oxygen. A method of taking in air outside the vehicle and supplying the outside air to the fuel cell is used to supply oxygen to the fuel cell.

In the process of supplying the air outside the vehicle to the fuel cell, the efficiency of the fuel cell generating the electricity may be deteriorated or the fuel cell may have a defect due to pollutants in the air. To prevent this problem, a filter is disposed in a line that supplies the outside air to the fuel cell. In order to increase the performance of the filter for filtering or removing the pollutants, the specifications of the filter may be designed to be stringent. For example, the amount of ion exchange resin in the filter may be increased.

However, in order to improve the specifications of the filter, the manufacturing cost of the filter may be increased. The filter with high (e.g., improved, stringent) specifications may increase the ventilation resistance and may deteriorate the efficiency of the fuel cell.

Additionally, when the filter is exposed to high-concentration ammonia, the lifetime of the filter may be significantly reduced.

Therefore, a method for preventing polluted air from being supplied to a fuel cell while maintaining the efficiency of the fuel cell without an increase in the manufacturing cost of a filter is required.

### SUMMARY

The present disclosure has been made to solve the above-mentioned problems occurring in the prior art while maintaining advantages achieved by the prior art.

An aspect of the present disclosure provides a hydrogen electric vehicle control device and method for preventing polluted air from being supplied to a fuel cell without an increase in the manufacturing cost of a filter.

Another aspect of the present disclosure provides a hydrogen electric vehicle control device and method for preventing polluted air from being supplied to a fuel cell while maintaining the efficiency of the fuel cell.

Another aspect of the present disclosure provides a hydrogen electric vehicle control device and method for preventing a reduction in the lifetime of a filter.

The technical problems to be solved by the present disclosure are not limited to the aforementioned problems. Any other technical problems solved by the present disclosure not mentioned herein should be clearly understood from the following description by those of ordinary skill in the art to which the present disclosure pertains.

According to an aspect of the present disclosure, a device for controlling a hydrogen electric vehicle includes a valve configured to open and close an inlet pipe configured to supply outside air to a fuel cell of the vehicle and a processor configured to control the valve. The processor is configured to determine location information of the vehicle and enter an outside air blocking mode and close the valve, based on the vehicle being located in a polluted area.

According to an embodiment, the device may further include a filter connected with the inlet pipe, and the valve may be configured to block the outside air from being introduced into the filter.

According to an embodiment, the polluted area may be an area where a concentration of ammonia gas in the air is greater than or equal to a threshold value.

According to an embodiment, the processor may determine a pigsty area from map information and may determine an area within a predetermined range from a center of the pigsty area as the polluted area.

According to an embodiment, the processor may determine a speed of the vehicle, based on the fact that the vehicle is located in the polluted area and may enter the outside air blocking mode when the speed of the vehicle is less than or equal to a threshold speed.

According to an embodiment, the processor may determine the speed of the vehicle at predetermined time intervals after entering the outside air blocking mode and may exit the outside air blocking mode in response to the speed of the vehicle being greater than or equal to the threshold speed.

According to an embodiment, the processor may control an air-conditioning system of the vehicle to operate in an inside air circulation mode based on the vehicle being in the outside air blocking mode.

According to an embodiment, in the outside air blocking mode, the processor may enter an EV mode and may control a driving motor to drive using power from a battery.

According to an embodiment, the processor may determine an operable time of the EV mode in the outside air blocking mode and may display the operable time of the EV mode on a display.

According to an embodiment, the processor may determine the operable time during which the vehicle is capable of operating in the EV mode, based on a state of charge (SOC) of the battery and a change in the SOC of the battery per unit time.

According to an embodiment, the processor may determine a possibility of the vehicle leaving the polluted area within the operable time of the EV mode, when the vehicle is not in a stopped state and may display a message through the display, when it is determined that the vehicle will not leave the polluted area within the operable time of the EV mode.

According to another aspect of the present disclosure, a method for controlling a hydrogen electric vehicle includes a step of determining, by a processor, location information of the vehicle, a step of determining, by the processor, information related to a polluted area where a preset concentration of a pollutant is estimated to be greater than or equal to a threshold value, and a step of controlling the vehicle, by the processor, to operate in an outside air blocking mode in which a valve located in line with an inlet pipe that supplies outside air to a fuel cell is closed, based on the vehicle being located in the polluted area.

According to an embodiment, the method may further include a step of determining a vehicle speed based on the vehicle being located in the polluted area, and the processor may perform the outside air blocking mode when the vehicle speed is greater than or equal to a threshold speed.

According to an embodiment, the step of performing the outside air blocking mode may include a step of controlling an air conditioning system to operate in an inside air circulation mode.

According to an embodiment, the step of performing the outside air blocking mode may include a step of controlling the vehicle to operate in an EV mode in which a driving motor of the vehicle is driven using power from a battery.

According to an embodiment, the step of performing the EV mode may include a step of determining an operable time of the vehicle in the EV mode, based on a state of charge (SOC) of the battery and a change in the SOC of the battery per unit time and a step of displaying the operable time of the EV mode on a display.

According to an aspect of the present disclosure, a hydrogen electric vehicle includes a fuel cell, an inlet pipe configured to supply air from outside the vehicle to the fuel cell, a valve configured to selectively block the inlet pipe and a flow of air from outside the vehicle to the fuel cell, and a processor configured to determine vehicle location information and enter an outside air blocking mode in which the valve blocks the flow of air from outside the vehicle to the fuel cell, based on the vehicle being in a polluted vehicle.

According to an embodiment, a hydrogen electric vehicle may include a filter coupled to the inlet pipe. The valve may be configured to selectively block the flow of air from outside the vehicle to the fuel cell from passing through the filter.

According to an embodiment, the polluted area may be an area where a concentration of ammonia gas in the air is greater than or equal to a threshold value.

According to an embodiment, the processor may be configured to control an air-conditioning system of the vehicle to operate in an inside air circulation mode based on the vehicle being in the outside air blocking mode.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a view for explaining a vehicle control method according to an embodiment of the present disclosure;

FIG. 2 is a view illustrating an air supply system according to an embodiment of the present disclosure;

FIG. 3 is a view illustrating an intake system according to an embodiment of the present disclosure;

FIG. 4 is a view illustrating a valve according to an embodiment of the present disclosure;

FIG. 5 is a view for explaining a filter and an operation of the filter according to an embodiment of the present disclosure;

FIG. 6 is a flowchart for explaining a method of controlling the air supply system according to an embodiment of the present disclosure;

FIG. 7 is a view illustrating a configuration of a vehicle control device according to another embodiment of the present disclosure;

FIGS. 8 and 9 are flowcharts for explaining a vehicle control method according to another embodiment of the present disclosure; and

FIG. 10 is a view illustrating a computing system according to an embodiment of the present disclosure.

### DETAILED DESCRIPTION

Hereinafter, some embodiments of the present disclosure are described in detail with reference to the drawings. In adding the reference numerals to the components of each drawing, it should be noted that identical or equivalent components are designated by identical reference numerals even when the components are displayed in different drawings. Further, in describing the embodiments of the present disclosure, a detailed description of well-known features or functions has been omitted in order to not unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. When a component, unit, controller, device, element, apparatus or the like of the present disclosure is described as having a purpose or performing an operation, function, or the like, the component, unit, controller, device, apparatus or element should be considered here as being “configured to” meet that purpose or perform that purpose or perform that operation or function. Each component, unit, controller, device, element, apparatus, and the like may separately embody or be included with a processor and a memory, such as a non-transitory computer readable media, as part of the apparatus.

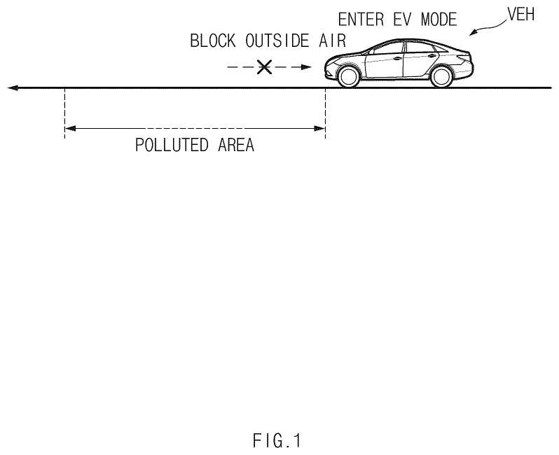

Hereinafter, embodiments of the present disclosure are described in detail with reference to FIGS. 1-10.

FIG. 1 is a view for explaining a vehicle control method according to an embodiment of the present disclosure.

Referring to FIG. 1, the vehicle control method according to an embodiment of the present disclosure may determine whether a vehicle VEH enters a polluted area.

According to an embodiment, a processor of the vehicle VEH may be configured to control an intake system of the vehicle VEH to block air outside the vehicle VEH from entering the vehicle VEH, when it is determined that the vehicle VEH enters the polluted area.

According to another embodiment, the processor of the vehicle VEH may change a driving mode of the vehicle VEH when it is determined that the vehicle VEH enters the polluted area. For example, the processor of the vehicle VEH may be configured to control a driving device of the vehicle VEH to cause the vehicle VEH to operate in an electric vehicle EV mode.

Hereinafter, a vehicle control method according to an embodiment of the present disclosure is described in more detail.

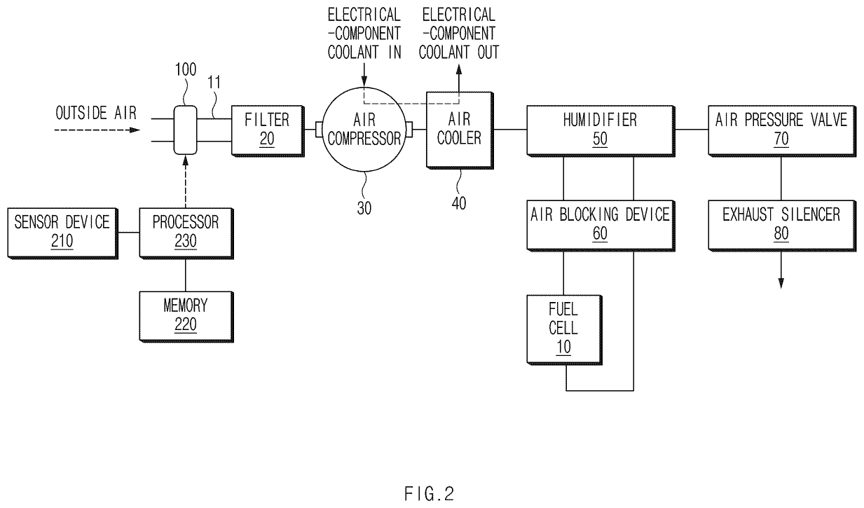

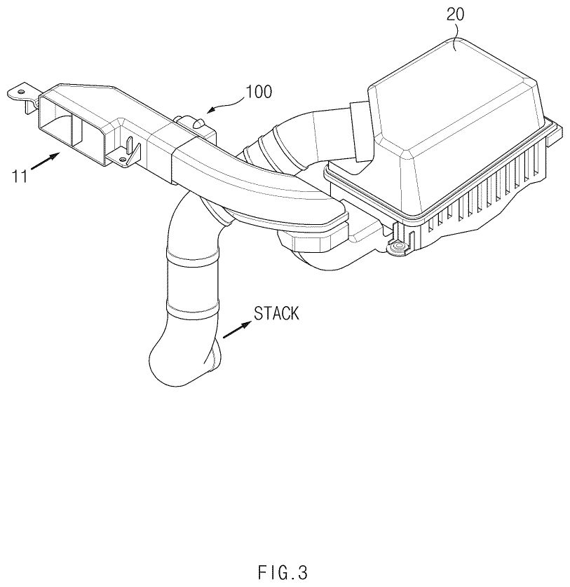

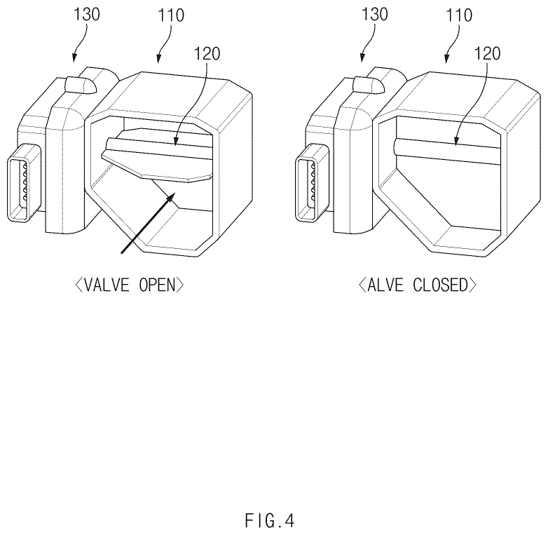

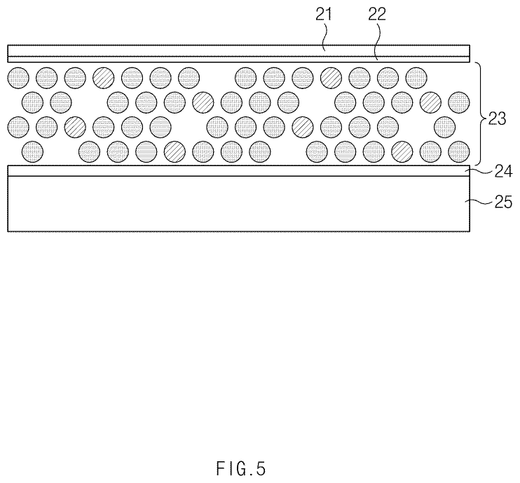

FIG. 2 is a view illustrating an air supply system according to an embodiment of the present disclosure. FIG. 3 is a view illustrating an intake system according to an embodiment of the present disclosure. FIG. 4 is a view illustrating a valve according to an embodiment of the present disclosure. FIG. 5 is a view for explaining a filter and an operation of the filter according to an embodiment of the present disclosure.

An air supply system according to an embodiment of the present disclosure is described with reference to FIGS. 2-5.

The air supply system according to an embodiment of the present disclosure may serve to supply air to a fuel cell 10 and may include the valve 100, the filter 20, an air compressor 30, an air cooler 40, a humidifier 50, an air blocking device 60, an air pressure valve 70, an exhaust silencer 80, a sensor device 210, a memory 220, and a processor 230.

The fuel cell 10 may generate electrical energy using an electrochemical reaction. The fuel cell 10 may have a stack structure in which multiple cells are stacked. Each of the cells may receive hydrogen gas contained in a fuel gas and air. Each of the cells may induce oxidation and reduction reactions. The cells may be protected from the outside by end plates and may include a membrane & electrode assembly (MEA) that oxidizes/reduces the hydrogen gas and the air and at least one separator for supplying the fuel gas and the air to the membrane & electrode assembly.

As illustrated in FIG. 3, the valve 100 may serve to open and close an inlet pipe 11 through which outside air is introduced. When the valve 100 is open, the outside air passing through the inlet pipe 11 may be supplied to the filter 20.

As illustrated in FIG. 4, the valve 100 may include a housing 110, a flap 120, and a valve controller 130.

The valve controller 130 may serve or be configured to rotate the flap 120. The valve controller 130 may generate a control signal (e.g., by itself) to rotate the flap 120, based on the location information of the vehicle VEH. Alternatively, the valve controller 130 may rotate the flap 120 under the control of the processor 230.

The housing 110 may provide a path along which the air is introduced. The flap 120 may be coupled to the housing 110 so as to rotate within the housing 110. In a closed state, the flap 120 may be located or disposed so as to block the air flow within the housing 110. In an open state, the flap 120 may provide a space where the air flows within the housing 110.

The filter 20 may serve to filter pollutants from the air introduced from outside the vehicle VEH. As illustrated in FIG. 5, the filter 20 may include an activated carbon layer 23 formed between a first cover 21 and a second cover 24. The first cover 21 and the second cover 24 may be spunbond. The activated carbon layer 23 may be a layer containing an ion exchange resin. Melt blown material 22 (e.g., fibers) for removing fine dust may be located on the inner side of the first cover 21. An auxiliary layer 25 for removing general dust may be formed on the outer side of the second cover 24.

The air compressor 30 may supply the air to the fuel cell 10 using rotation of a blower.

The air cooler 40 may serve or be configured to decrease or reduce heat generated by an operation of the air compressor 30.

The air humidified by the humidifier 50 may be supplied to the fuel cell 10 with its pressure adjusted by or using the air blocking device 60.

The air pressure valve 70 may adjust the pressure on the outlet side of the fuel cell 10 and may discharge the air through the exhaust silencer 80.

The sensor device 210 may include one or more sensors for obtaining the status information of the vehicle VEH and the location information of the vehicle VEH. The sensor device 210 may obtain the location information of the vehicle VEH using a global navigation satellite system (GNSS), for example, a global positioning system (GPS).

The memory 220 may serve to store an algorithm and map information for an operation of the processor 230. The map information may mean a precious map. The memory 220 may use a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), or a double date rate-SDRAM (DDR-SDRAM).

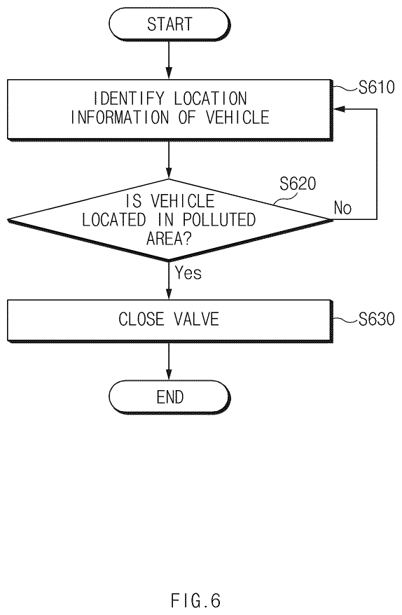

The processor 230 may be configured to control the valve 100, based on the location information of the vehicle VEH. An operation of the processor 230 configured to control the air supply system is described with reference to FIG. 6.

FIG. 6 is a flowchart for explaining a method of controlling the air supply system according to an embodiment of the present disclosure.

In step S610, the processor 230 may identify the location information of the vehicle VEH.

The processor 230 may receive the location information of the vehicle VEH from the sensor device 210. Alternatively, the processor 230 may receive the location information of the vehicle VEH from a navigation system mounted on a cluster.

In step S620, the processor 230 may determine whether the vehicle VEH is located in a polluted area.

The processor 230 may search for the map information to obtain information on the surroundings of the vehicle VEH and may determine, for example, the location of the polluted area from the information on the surroundings.

The polluted area may be set as an area where the concentration of ammonia (NH₃) in the air is greater than or equal to a threshold value. For example, a pigsty area (i.e., a dirty or messy place, such as near animal operations, landfills, dumps, and the like) with high ammonia emissions may be set as the polluted area. The polluted area may be set as an area within a certain or predetermined radius from the center of the pigsty or an area within a certain or predetermined distance from the boundary of the pigsty.

In step S630, the processor 230 may enter an outside air blocking mode and may close the valve 100 when the vehicle VEH is located in the polluted area (YES in S620). In the outside air blocking mode for blocking or preventing outside air from being supplied to the fuel cell 10, the processor 230 may perform an operation different from an operation in an inside air circulation mode for blocking outside air from being introduced into the interior of the vehicle VEH.

Due to the closing of the valve 100, the introduction of outside air may be blocked, and high-concentration ammonia may be prevented from being supplied to the filter 20. According to an embodiment of the present disclosure, the introduction of outside air may be blocked in a polluted area with a high concentration of ammonia, and therefore polluted air containing ammonia may be prevented from being supplied to the fuel cell 10 and degrading the performance of the filter 20.

When the valve 100 is closed, the blower of the air compressor 30 for supplying air to the fuel cell 10 may be in an overloaded state.

Therefore, the processor 230 may limit the output of the fuel cell 10 and may enter the outside air blocking mode while the vehicle is in the EV mode in which a driving motor is driven by a battery. Alternatively, when the Vehicle VEH is not in the EV mode, the processor 230 may control the vehicle VEH enter the outside air blocking mode and may perform a mode transition to the EV mode.

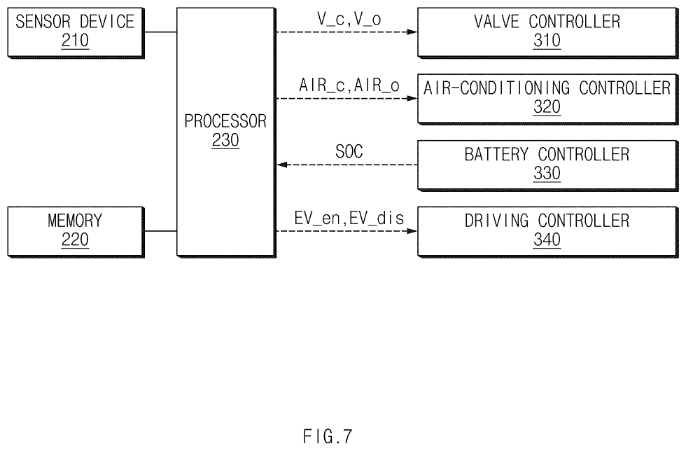

FIG. 7 is a view illustrating a configuration of a vehicle control device according to another embodiment of the present disclosure.

Referring to FIG. 7, the vehicle control device according to another embodiment of the present disclosure may include a sensor device 210, a processor 230, a valve controller 310, an air-conditioning controller 320, a battery controller 330, and a driving controller 340. With reference to FIG. 7, detailed descriptions of components identical to the components in the embodiments described above have been omitted. In addition, a power system for operating in an EV mode and an engine mode by the driving controller 340 in FIG. 7 are well-known technologies, and therefore a detailed description thereof has been omitted.

The sensor device 210 may obtain the location information of the vehicle VEH.

The processor 230 may enter an outside air blocking mode when the vehicle VEH is located in a polluted area.

In the outside air blocking mode, the processor 230 may transmit a valve closing request signal V_c to the valve controller 310. When the outside air blocking mode is released or exited, the processor 230 may transmit a valve opening request signal V_o to the valve controller 310.

In the outside air blocking mode, the processor 230 may transmit an inside air circulation request signal AIR_c to the air-conditioning controller 320. When the outside air blocking mode is released or exited, the processor 230 may transmit an inside air circulation release request signal AIR_o to the air-conditioning controller 320.

In the outside air blocking mode, the processor 230 may receive information on a state of charge (SOC) of the battery from the battery controller 330. The processor 230 may determine the operable time of the EV mode in the outside air blocking mode, based on the SOC of the battery.

In the outside air blocking mode, the processor 230 may transmit an EV mode entrance request signal EV_en to the driving controller 340. When the outside air blocking mode is released or exited, the processor 230 may transmit an EV mode release request signal EV_dis to the driving controller 340.

The valve controller 310 may close the valve 100 in response to the valve closing request signal V_c and may open the valve 100 in response to the valve opening request signal V_o.

The air-conditioning controller 320 may operate an air-conditioning system in an inside air circulation mode in response to the inside air circulation request signal AIR_c to prevent air outside the vehicle VEH from being introduced into the interior of the vehicle VEH. Accordingly, the air in the polluted area may be prevented from entering the vehicle VEH and causing an unpleasant feeling or experience to an occupant of the vehicle VEH. The air-conditioning controller 320 may switch the air-conditioning system to an outside air circulation mode in response to the inside air circulation release request signal AIR_o.

The battery controller 330 may serve to monitor the overall status of the battery for driving the driving motor. The battery controller 330 may obtain status information including the SOC of the battery, based on information obtained using a sensor of the battery.

The driving controller 340 may control driving of the wheels of the vehicle VEH using the engine or the driving motor depending on the driving mode of the vehicle VEH. The driving controller 340 may enter the EV mode while the vehicle is in the outside air blocking mode. The driving controller 340 may control the driving motor to drive the vehicle VEH using (e.g., power stored in) the battery. When the outside air blocking mode is released or exited, the driving controller 340 may drive the vehicle VEH in the engine mode or a hybrid mode using the engine. To achieve this, the driving controller 340 may include an engine controller, a clutch controller, a motor controller, a brake controller, and a transmission controller.

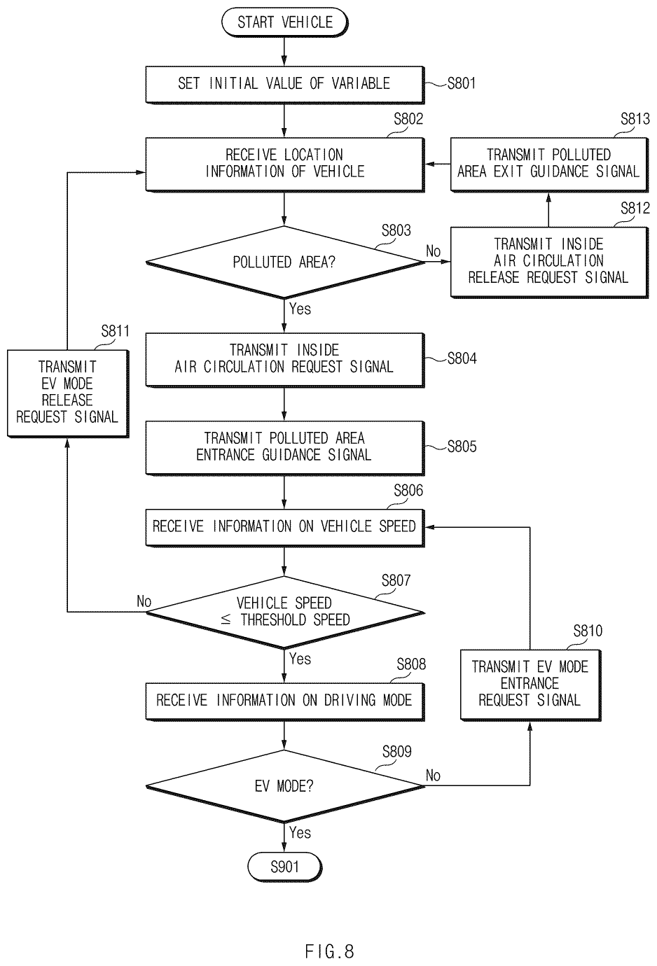

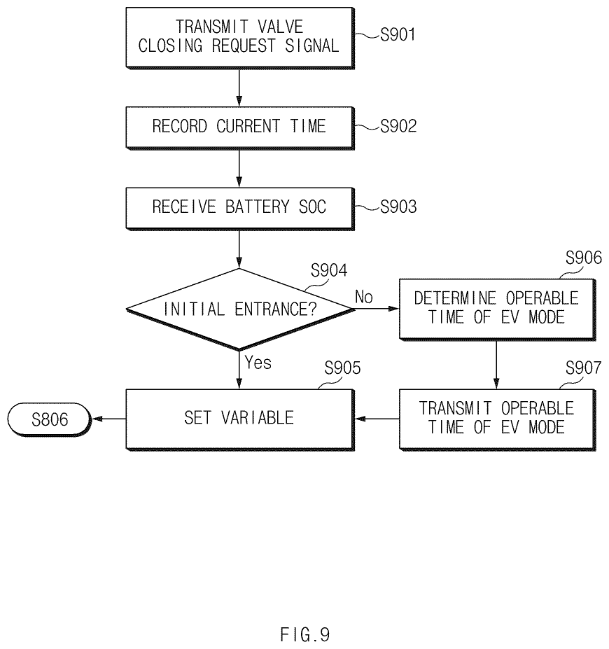

FIGS. 8 and 9 are flowcharts for explaining a vehicle control method according to another embodiment of the present disclosure.

The vehicle control method according to another embodiment of the present disclosure is described with reference to FIGS. 7-9.

The vehicle control method according to another embodiment of the present disclosure may operate in response to starting the vehicle VEH.

In step S801, the processor 230 may set initial values of variables.

The variables may include variables for determining the timing of when the vehicle VEH enters a polluted area and operates in the outside air blocking mode. In addition, the variables may be used to determine the operable time of the EV mode. The variables may include a first time variable T_i, a second time variable T_a, a first SOC variable SOC_i, and a second SOC variable SOC_a. In step S801, the first time variable T_i, the second time variable T_a, the first SOC variable SOC_i, and the second SOC variable SOC_a may all be set to 0 (zero).

In step S802, the processor 230 may receive the location information of the vehicle VEH from the sensor device 210.

In step S803, the processor 230 may determine whether the vehicle VEH is located in a polluted area, based on a location signal of the vehicle VEH.

In step S804, the processor 230 may enter the outside air blocking mode in response to the vehicle VEH being located in the polluted area (YES in S803).

In the outside air blocking mode, the processor 230 may transmit the inside air circulation request signal AIR_c to the air-conditioning controller 320. The air-conditioning controller 320 may operate an inside air circulation system of the vehicle VEH, based on the inside air circulation request signal AIR_c from the processor 230.

In step S805, the processor 230 may transmit a polluted area entrance guidance signal to the cluster in the outside air blocking mode.

In response to the polluted area entrance guidance signal, the cluster may display indicia (e.g., a light, icon, text, or the like) indicating the entrance of the vehicle VEH into the polluted area through a display.

In step S806, in the outside air blocking mode, the processor 230 may receive information on the speed of the vehicle VEH from the sensor device 210 or the navigation system of the cluster. The speed information may be information indicating the vehicle speed that is the longitudinal speed of the vehicle VEH.

In step S807, in the outside air blocking mode, the processor 230 may compare the vehicle speed with a preset threshold speed.

In step S808, in the outside air blocking mode, when or based on the fact that the vehicle speed is less than or equal to the threshold speed (YES in S807), the processor 230 may receive information on the driving mode of the vehicle VEH from the driving controller 340.

The driving mode information may be information that informs the processor 230 of the driving mode of the vehicle VEH. The driving mode may include the EV mode and the engine mode. The driving mode information may indicate that the vehicle VEH is driving in the EV mode or the engine mode.

In step S809, in the outside air blocking mode, the processor 230 may identify the driving mode information and may determine whether the driving mode is the EV mode.

In step S810, in the outside air blocking mode, the processor 230 may transmit the EV mode entrance request signal EV_en to the driving controller 340 when the driving mode is not the EV mode (NO in S809).

The driving controller 340 may operate the driving motor using the power of (e.g., stored in) the battery in response to the EV mode entrance request signal EV_en.

In step S811, the processor 230 may transmit the EV mode release request signal EV_dis to the driving controller 340 when the vehicle speed is greater than the threshold speed (NO in S807).

When the speed of the vehicle VEH is above a certain or predetermined level, for example, when the speed of the vehicle VEH is greater than or equal to the threshold speed, the influence of the outside air introduced into the intake pipe by the driving wind (e.g., air incident on the vehicle as it moves) may be limited. In addition, when the speed of the vehicle VEH is above a certain or predetermined level, the amount of outside air introduced into the intake pipe may be small because the vehicle VEH is capable of rapidly leaving the polluted area.

Accordingly, when the speed of the vehicle VEH is greater than or equal to the threshold speed, the processor 230 may perform a procedure to release the outside air blocking mode. For example, the driving controller 340 may change the driving mode from the EV mode to the engine mode in response to the EV mode release request signal EV_dis.

In step S812, the processor 230 may transmit the inside air circulation release request signal AIR_o to the air-conditioning controller 320 when the processor 230 determines that the vehicle VEH is not located in the polluted area (NO in S803).

The air-conditioning controller 320 may release or exit the inside air circulation mode in response to the inside air circulation release request signal AIR_o.

In step S813, the processor 230 may transmit a polluted area exit signal to the cluster.

In response to the polluted area exit signal, the cluster may inform (e.g., a driver) of the departure of the vehicle VEH away from the polluted area through the display.

In step S901 of FIG. 9, the processor 230 may transmit the valve closing request signal V_c to the valve controller 310 in the EV mode.

The valve controller 310 may close the valve 100 in response to the valve closing request signal V_c. When the valve 100 is in the closed state, the closed state of the valve 100 may be maintained.

In step S902, the processor 230 may identify the time and may set the second time variable T_a based on the identified time. Step S902 may be performed at predetermined time intervals, and the second time variable T_a may be reset at or after every predetermined interval of time.

In step S903, the processor 230 may receive battery information from the battery controller 330.

The battery information may include a battery state of charge (SOC). The battery SOC may be the SOC of the battery measured at the time when the battery information is transmitted. The battery SOC may be the battery SOC at or corresponding to the second time variable T_a, and the processor 230 may set the second SOC variable SOC_a, based on the received battery SOC.

In step S904, the processor 230 may determine whether it is time to enter the outside air blocking mode.

The processor 230 may determine whether it is time to enter the outside air blocking mode, by determining whether the variables are set to the initial values. When the first time variable T_i or the first SOC variable SOC_i is 0 (zero), the processor 230 may determine that the timing of performing step S904 is the time point at which the processor 230 enters the outside air blocking mode.

In step S905, the processor 230 may reset the variables at the time when the processor 230 enters the outside air blocking mode.

According to an embodiment, the processor 230 may set the first time variable T_i to the second time variable T_a obtained in step S802. In other words, the processor 230 may set T_i=T_a.

In addition, the processor 230 may set the first Soc variable SOC_i to the second SOC variable SOC_a. In other words, the processor 230 may set SOC_i=SOC_a.

In step S906, the processor 230 may determine the operable time of the EV mode.

The operable time of the EV mode may mean the period of time during which the vehicle VEH is capable of being driven based on the SOC of the battery.

The processor 230 may determine the operable time of the EV mode, based on the measured SOC of the battery and a change in SOC during a unit period of time.

The measured SOC of the battery may be the second SOC variable SOC_a set in step S803.

The unit period of time may be a period from the first time variable T_i to the second time variable T_a.

The change in SOC may mean the difference between the SOC at or corresponding to the first time variable T_i and the SOC at or corresponding to the second time variable T_a and may be calculated based on the difference between the first SOC variable SOC_i and the second SOC variable SOC_a.

According to an embodiment, the processor 230 may determine the operable time T_re of the EV mode, based on Equation 1 below.

$$T\_re = \frac{SOC\_a}{Δ S O C} Δ SOC = \frac{SOC\_i - SOC\_a}{T\_a - T\_i} \qquad [ Equation 1 ]$$

In step S907, the processor 230 may provide the operable time of the EV mode to the cluster.

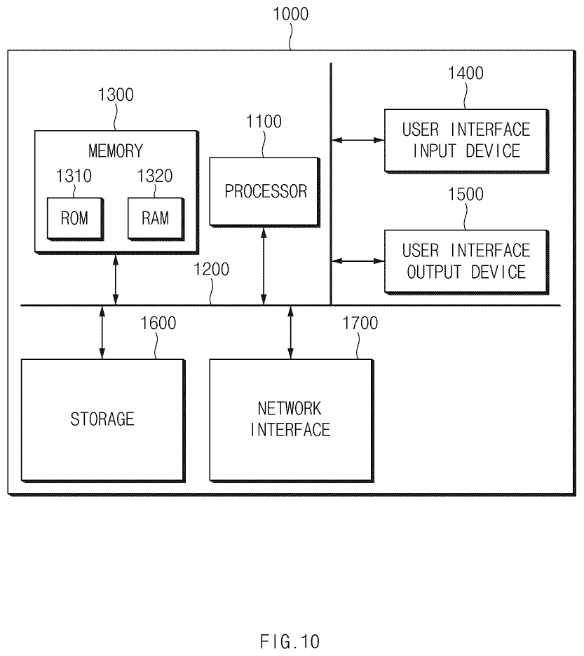

FIG. 10 is a view illustrating a computing system according to an embodiment of the present disclosure.

Referring to FIG. 10, the computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (the memory 1300 and/or the storage 1600) such as a RAM, a flash memory, a ROM, an EPROM, an EEPROM, a register, a hard disk, a removable disk, or a CD-ROM.

The storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to the embodiments of the present disclosure, the hydrogen electric vehicle control device and method may block the introduction of outside air in the polluted area, thereby preventing polluted air from being supplied to the fuel cell without requiring the filter to have too stringent of specifications.

Furthermore, according to the embodiments of the present disclosure, the hydrogen electric vehicle control device and method may prevent polluted air from being supplied to the fuel cell without requiring the specifications of the filter to be excessively high, thereby preventing the efficiency of the fuel cell from being deteriorated, for example, due to increased ventilation resistance due to the specifications of the filter.

Moreover, according to the embodiments of the present disclosure, the hydrogen electric vehicle control device and method may prevent high-concentration pollutants from being supplied to the filter, thereby solving the problem of the shortening of the lifetime of the filter due to the high-concentration pollutants.

In addition, the present disclosure may provide various effects that are directly or indirectly recognized.

Hereinabove, although the present disclosure has been described with reference to several embodiments and the accompanying drawings, the present disclosure is not limited thereto. The present disclosure may be variously modified and altered by those of ordinary skill in the art to which the present disclosure pertains without departing from the spirit and scope of the present disclosure claimed in the following claims.

Therefore, several embodiments of the present disclosure are provided to explain the spirit and scope of the present disclosure, but not to limit them. Accordingly, the spirit and scope of the present disclosure is not limited by the embodiments described herein. The scope of the present disclosure should be construed on the basis of the accompanying claims, and all the technical ideas within q scope equivalent to the claims should be included in the scope of the present disclosure.

What is claimed is:

1. A device for controlling a hydrogen electric vehicle, the device comprising:
a valve configured to open and close an inlet pipe configured to supply outside air to a fuel cell of the vehicle; and
a processor configured to control the valve,
wherein the processor is configured to:
determine location information of the vehicle; and
enter an outside air blocking mode and close the valve, based on the vehicle being located in a polluted area.

2. The device of claim 1, further comprising:
a filter connected with the inlet pipe,
wherein the valve is configured to block the outside air from being introduced into the filter.

3. The device of claim 1, wherein the polluted area is an area where a concentration of ammonia gas in the air is greater than or equal to a threshold value.

4. The device of claim 3, wherein the processor is configured to:
determine a pigsty area from map information; and
determine an area within a predetermined range from a center of the pigsty area as the polluted area.

5. The device of claim 1, wherein the processor is configured to:
determine a speed of the vehicle, based on the vehicle being located in the polluted area; and
enter the outside air blocking mode based on the speed of the vehicle being less than or equal to a threshold speed.

6. The device of claim 5, wherein the processor is configured to:
determine the speed of the vehicle at predetermined time intervals after entering the outside air blocking mode; and
exit the outside air blocking mode based on the speed of the vehicle being greater than or equal to the threshold speed.

7. The device of claim 1, wherein the processor is configured to control an air-conditioning system of the vehicle to operate in an inside air circulation mode based on the vehicle being in the outside air blocking mode.

8. The device of claim 1, wherein the processor is configured to enter an EV mode and control a driving motor to drive using power from a battery, in the outside air blocking mode.

9. The device of claim 8, wherein the processor is configured to:
determine an operable time of the EV mode in the outside air blocking mode; and
display the operable time of the EV mode on a display.

10. The device of claim 9, wherein the processor is configured to determine the operable time during which the vehicle is cable of operating in the EV mode, based on a state of charge (SOC) of the battery and a change in the SOC of the battery per unit time.

11. The device of claim 9, wherein the processor is configured to:
determine a possibility of the vehicle leaving the polluted area within the operable time of the EV mode, based on the vehicle not being in a stopped state; and
display a message through the display, based on a determination that the vehicle will not leave the polluted area within the operable time of the EV mode.

12. A method for controlling a hydrogen electric vehicle, the method comprising:
determining, by a processor, location information of the vehicle;
determining, by the processor, information related to a polluted area where a concentration of a pollutant is estimated to be greater than or equal to a threshold value; and
controlling the vehicle, by the processor, to operate in an outside air blocking mode in which a valve located in line with an inlet pipe configured to supply outside air to a fuel cell is closed, based on the vehicle being located in the polluted area.

13. The method of claim 12, further comprising:
determining a vehicle speed based on the vehicle being located in the polluted area,
wherein determining a vehicle speed includes performing the outside air blocking mode based on a determination that the vehicle speed is greater than or equal to a threshold speed.

14. The method of claim 12, wherein performing the outside air blocking mode includes controlling an air conditioning system to operate in an inside air circulation mode.

15. The method of claim 12, wherein performing the outside air blocking mode includes controlling the vehicle to operate in an EV mode in which a driving motor of the vehicle is driven using power from a battery.

16. The method of claim 15, wherein performing the EV mode includes:
determining an operable time of the vehicle in the EV mode, based on a state of charge (SOC) of the battery and a change in the SOC of the battery per unit time; and
displaying the operable time of the EV mode on a display.

17. A hydrogen electric vehicle comprising:
a fuel cell;
an inlet pipe configured to supply air from outside the vehicle to the fuel cell;
a valve configured to selectively block the inlet pipe and a flow of air from outside the vehicle to the fuel cell; and
a processor configured to determine vehicle location information and enter an outside air blocking mode in which the valve blocks the flow of air from outside the vehicle to the fuel cell, based on the vehicle being in a polluted vehicle.

18. The hydrogen electric vehicle of claim 17, further comprising:
a filter coupled to the inlet pipe,
wherein the valve is configured to selectively block the flow of air from outside the vehicle to the fuel cell from passing through the filter.

19. The hydrogen electric vehicle of claim 17, wherein the polluted area is an area where a concentration of ammonia gas in the air is greater than or equal to a threshold value.

20. The hydrogen electric vehicle of claim 17, wherein the processor is configured to control an air-conditioning system of the vehicle to operate in an inside air circulation mode based on the vehicle being in the outside air blocking mode.
